(19) United States
(12) Patent Application Publication
(10) Pub. No.: US 2012/0162632 A1
(43) Pub. Date: Jun. 28, 2012

(54) Real-Time Processing Method and System

(75) Inventor: Neale Dutton, Edinburgh (GB)

(73) Assignee: STMicroelectronics (Research & Development) Limited, Marlow (GB)

(21) Appl. No.: 13/242,925

(22) Filed: Sep. 23, 2011

(30) Foreign Application Priority Data
Dec. 22, 2010 (GB) 1021662.0

(51) Int. Cl. G01C 3/06

(52) U.S. Cl. 356/5.01

(57) ABSTRACT

An optical range finder includes a light source adapted to produce illumination which impinges on a target. A detector receives a reflection of the illumination from the target, and a range code generator generates from the detected reflection a range code indicative of the range of the target from the range finder for each pulse. A signal processor receive plural range codes over a predetermined interval. A content addressable memory is used to count how many identical range codes are received during the predetermined interval. An identification is then made of the range code with the highest count, and that range code with the highest count is output as indicative of the range of the target from the range finder.

### PRIORITY CLAIM

This application claims priority from United Kingdom Application for Patent No. 1021662.0 filed Dec. 22, 2010, the disclosure of which is incorporated by reference.

### TECHNICAL FIELD

The present invention relates to a real-time processing method and system, preferably for an optical range finding device or system using a content addressable memory.

### BACKGROUND

Optical range finding devices for use in real-time applications such as laser speed guns or 3D cameras typically capture many frames per second. The captured frames need to be processed instantaneously to determine the target range. This requires a processing method which can process different incoming range values every clock cycle for a defined number of exposure periods and immediately output the range value which occurs most regularly.

Current range finding devices and SPAD-based 3D cameras require time after each exposure period to process the incoming data in order to form an average with the previous samples. This post-hoc analysis is time consuming.

Current known optical range finders average a large number of results to obtain an accurate range result. This averaging can be performed as a rolling average or by binning the results into a histogram. Both of these averaging methods are computationally intensive post-hoc analyses which take up considerable time.

Current range finding systems always require some post-event processing time to calculate the target distance from the data cumulatively gained during the exposure periods. This is a problem for range finders and other devices which need to output results constantly and quickly.

Content addressable memory (CAM) technology is well known and has been used in situations where the memory location of stored data is unknown and is required immediately. For example, a CAM would be useful where a memory search would be prohibitive in processing time or for applications such as the real-time packet routing for Internet Protocol devices.

There is a need in the art to overcome at least some of the foregoing problems and provide a range finder that can accurately determine range in real time. The is also a need to provide a processing circuit for range finders and the like which can handle data processing in real time.

### SUMMARY

According to one aspect there is provided an optical range finder comprising a light source adapted to produce illumination which impinges on a target; a detector adapted to receive a reflection of the illumination from the target; a range code generator adapted to pulse the light source and to generate a range code indicative of the range of the target from the range finder for each pulse; a signal processor including a content addressable memory (CAM) adapted to receive the range codes and count the frequency of identical range codes in a predetermined interval to identify the range code with the highest count which range code with the highest count is indicative of the range of the target from the range finder.

Optionally, the optical range finder further comprises a read access memory (RAM) for counting the numbers of each range code

Optionally, the CAM includes a plurality of memory locations each adapted to store an incoming range codes.

Optionally, the RAM includes a plurality of counters each associated with one of the CAM memory locations.

Optionally, the counter for each memory location is augmented by one each time a range code is received at the corresponding CAM memory location

Optionally, the signal processor includes a register for measuring and storing the highest count at any time.

Optionally, at a predetermined threshold the highest count is read out as the range code that equates to the range of the target from the range finder.

Optionally, the range code generator comprises a time to digital converter (TDC).

According to a second embodiment there is provided a processing circuit for use in an optical range finder as defined herein, wherein the processing circuit is adapted to measure the frequency of counts of identical range codes in a predetermined interval in order to identify a range code with the highest count wherein the range code with the highest count is indicative of the range of a target from a range finder.

According to a third embodiment there is provided a method of measuring the range of a target from an optical range finder of the type comprising a light source; a detector; a range code generator; and a signal processor, the method comprising the steps of: illuminating the target using the light source; receiving reflected illumination from the target at the detector; pulsing the light source; generating a range code indicative of the range of the target from the range finder for each pulse; counting the frequency of identical range codes in a predetermined interval to identify the range code with the highest count which range code with the highest count is indicative of the range of the target from the range finder.

The foregoing solutions offer the following advantages. The system, based on a content addressable memory, will immediately provide a distance value after a chosen integration period without the need for further computation. This would enable the range finder to enter a power saving mode, or take the next set of measurements without delay.

### BRIEF DESCRIPTION OF THE DRAWINGS

Reference will now be made, by way of example, to the accompanying drawings, in which:

FIG. 1 is a block diagram of an optical range finder system, in accordance with an embodiment,

FIG. 2 is a histogram of range counts for the FIG. 1 system, in accordance with an embodiment, and

FIG. 3 is a block diagram of a digital signal processor for use in the FIG. 1 system, in accordance with an embodiment.

### DETAILED DESCRIPTION OF THE DRAWINGS

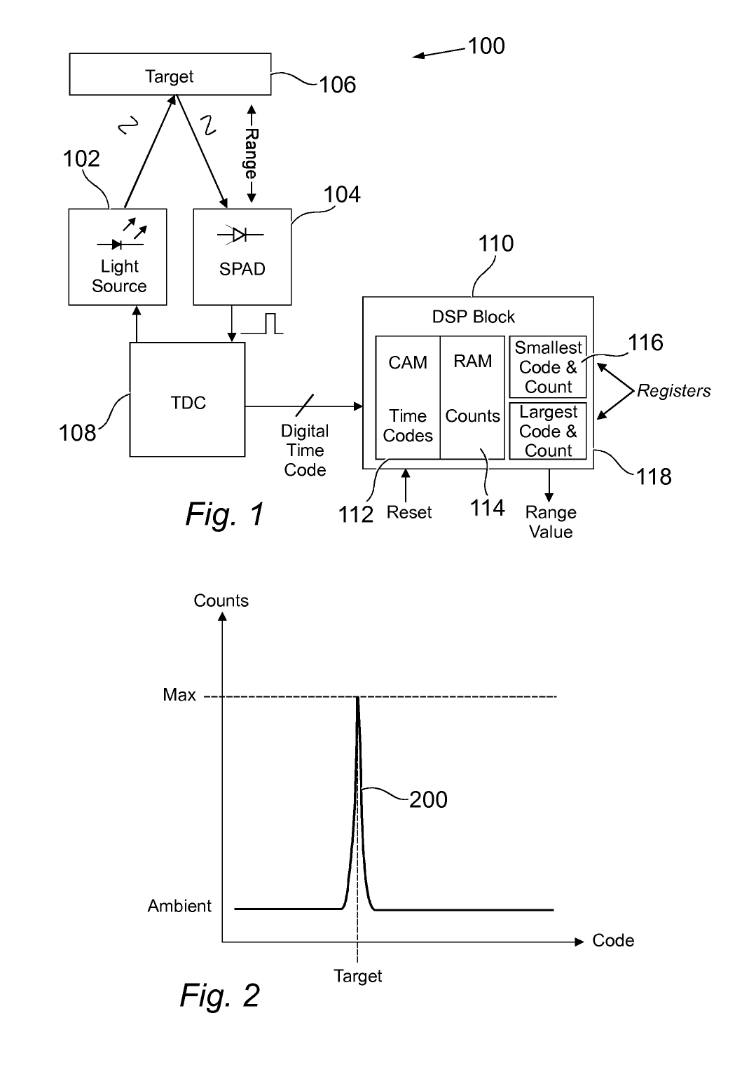

Referring to FIG. 1, an optical range finder system 100 is shown. The system includes a light source 102 and a detector 104 such as a single photodiode avalanche device (SPAD). The light source illuminates a target 106 and the detector collects the illumination reflected from the target. A time to digital converter (TDC) 108 controls the pulsing of the light source and receives the reflected illumination from the detector. The TDC 108 is a device which outputs a digital code corresponding to the measured time interval between two events. In this case, the time between the illumination of the light source and a reception of a pulse at the detector signaling a reflection back from the target. This information can then be used to determine the distance or range to the target. The time of flight (TOF) is measured between the time the light source is pulsed and the time at which the reflected pulse is returned. The output from the TDC is then passed to a digital signal processor (DSP) 110 for processing. This will be described in greater detail below.

The detector can be of any appropriate type, for example a single photon avalanche diode (SPAD), an electron bombarded charge coupled device (EMCCD) or some other similar ultra low light detection device. Similarly, the light source can be any convenient type, including a pulsed laser or a light emitting diode (LED).

The digital signal processor includes a content addressable memory (CAM) 112; a read access memory (RAM) 114; and first and second registers 116 and 118 respectively.

In use the light source is pulsed every clock cycle (or multiple thereof) of the TDC. The light impinges on the target, is reflected back to the detector and then sampled by the TDC. A digital range code is output from the TDC in each successive clock cycle. The different range codes must be accumulated together in order to determine the distance to the target from the optical range finder. The TDC acts as a range code generator by measuring the interval between pulses which directly represent the distance traveled from the light source to the target and then back to the detector.

If an ambient photon strikes the SPAD detector before a returning photon, an incorrect code may be output by the TDC. Ambient light produces a uniform distribution or broad band noise in the accumulated output codes as shown in FIG. 2. On the other hand a reflected illumination from a static target object will return the same code many times producing a normal curve 200 as shown in the histogram of accumulated counts in FIG. 2.

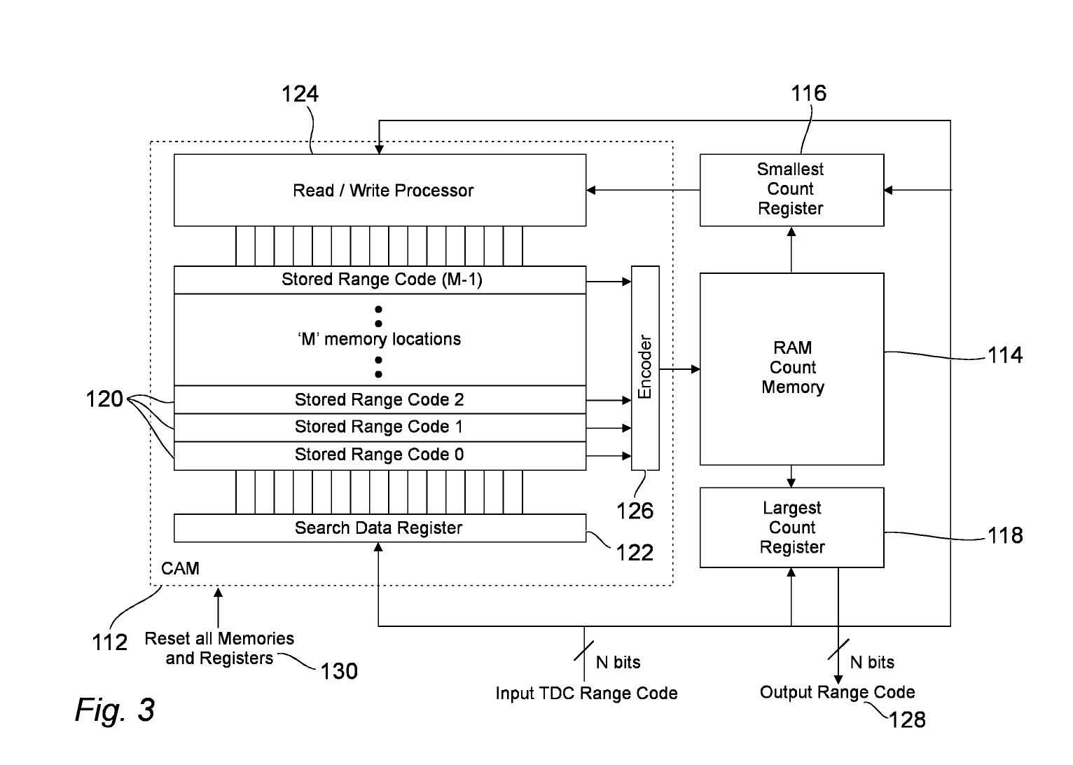

Each output code from the TDC is processed by the DSP block 110 as detailed with reference to FIG. 3. The DSP 110 includes a content addressable memory (CAM) 112; a read access memory (RAM) 114; and first and second registers 116 and 118 respectively. The CAM includes a plurality of memory locations 120, each of which stores the incoming individual range codes (0 to M-1).

An input TDC range code is entered in a search data register 122 and simultaneously to a read/write processor 124. If the memory locations are empty (as there has been a reset or the process has just started) the input range codes are entered sequentially into the memory locations to become stored range codes in the memory locations. The appropriate location is identified by the search data register and written to the identified location by the read/write processor. If inputs have already been entered into the CAM memory locations and the search data register recognizes a range code as matching a range code already in a memory location, the range code memory location in the CAM is output via an encoder 126 to a RAM count memory 114. The RAM count memory includes a plurality of counters associated with each memory location 120. Each time a range code of a particular value is passed to the relevant counter the counter value associated with the memory location is incremented by one.

As each input code arrives from the TDC the corresponding count value is compared and the range code with the highest count is determined and stored in the largest count register 118 and the range code with the smallest count is written to the smallest count register 116.

If the CAM and/or RAM count memories are full, the range code in the smallest count register, with the lowest count, is overwritten. This clears a space in both the CAM memory location and the RAM count register to allow for the next incoming range code.

Once the highest or largest count value in the largest count register passes a defined threshold and/or a defined value above another significant count or calculated value, the output range code 128 is read out. Thus the highest count equates to the most likely range of the target from the range finder. If the outputs from all the counters were plotted for a given integration period, a graph similar to that in FIG. 2 would be produced. The predetermined threshold may be based on a particular integration period or may be a predetermined value or any other appropriate threshold. Once an output range code is produced, the DSP block is subsequently reset 130 for another accumulation period.

Real-time processing of incoming range values enables a range value to be output immediately after a definable number of exposure/integration cycles.

It should be noted that the terms “optical”, “illumination” and “light” are intended to cover any wavelength ranges in the electromagnetic spectrum and are not limited to the visual spectrum.

The present invention may include any type of detector including SPAD type detectors, or any other appropriate type. It will be appreciated that for each type of detector a different illumination sensor may be used required. It will also be appreciated that using different detectors or sensors may result in different required modules, orientations and modes of operation.

The range finder of the present invention can be used in many different environments including, but not limited to: 2D cameras, 3D cameras, cameras such as speed cameras and the like; range finders for photography applications, military or security applications, oceanographic applications, depth profiling, computer interaction, human computer interfaces (HCl), gesture recognition, mapping and surveying; sports applications and many other environments.

It will also be appreciated that the DSP block of the present invention could be used in other environments where counts are processed and measured. Such environments may include medical imaging such as positron emission tomography (PET) imaging and nuclear science for particle detection:

The above mentioned optical range finder may be implemented in hardware, software or any appropriate combination thereof. As such it will be appreciated that at least some of the functions above described in a hardware sense may be replaced by an appropriate software equivalent.

It will be appreciated that many variations of the invention could apply and are intended to be encompassed within the scope of the claims.

What is claimed is:

1. Apparatus comprising an optical range finder comprising:
a light source adapted to produce illumination which impinges on a target;
a detector adapted to receive a reflection of the illumination from the target;
a range code generator adapted to pulse the light source and to generate a range code indicative of the range of the target from the range finder for each pulse;
a signal processor including a content addressable memory adapted to receive the range codes and count a frequency of identical range codes in a predetermined interval to identify the range code with a highest count, said range code with the highest count being indicative of the range of the target from the range finder.

2. The apparatus of claim 1, further comprising a read access memory for counting the numbers of each range code.

3. The apparatus of claim 2, wherein the content addressable memory includes a plurality of memory locations each adapted to store incoming range codes.

4. The apparatus of claim 3, wherein the read access memory includes a plurality of counters each associated with one of the content addressable memory locations.

5. The apparatus of claim 4, wherein the counter for each memory location is augmented by one each time a range code is received at the corresponding content addressable memory location.

6. The apparatus of claim 1, wherein the signal processor includes a register for measuring and storing the highest count at any time.

7. The apparatus of claim 6, wherein at a predetermined threshold the highest count is read out as the range code that equates to the range of the target from the range finder.

8. The apparatus of claim 1, wherein the range code generator comprises a time to digital converter.

9. The apparatus of claim 1 wherein the apparatus is a camera.

10. The apparatus of claim 1 wherein the apparatus is a computer.

11. A processing circuit including a content addressable memory adapted to receive code values and count a frequency of identical code values in a predetermined interval to identify the code value with a highest count.

12. The processing circuit of claim 11 wherein said code values comprise range codes indicative of with the highest count being indicative of a range between a target and a range finder, said processing circuit adapted to measure the frequency of counts of identical range codes in a predetermined interval in order to identify a range code with a highest count, said range code with the highest count being indicative of the range between the target and the range finder.

13. The processing circuit of claim 1, further comprising a read access memory for counting the numbers of each code value.

14. The processing circuit of claim 13, wherein the content addressable memory includes a plurality of memory locations each adapted to store incoming code values.

15. The processing circuit of claim 14, wherein the read access memory includes a plurality of counters each associated with one of the content addressable memory locations.

16. The processing circuit of claim 15, wherein the counter for each memory location is augmented by one each time a code value is received at the corresponding content addressable memory location.

17. The processing circuit of claim 11, wherein the signal processor includes a register for measuring and storing the highest count at any time.

18. A method of measuring the range of a target from an optical range finder of the type comprising a light source; a detector; a range code generator; and a signal processor, the method comprising the steps of:
pulsing the light source illuminating the target;
receiving reflected illumination from the target at the detector;
generating a range code indicative of the range of the target from the range finder for each pulse;
counting the frequency of identical range codes in a predetermined interval to identify the range code with the highest count which range code with the highest count is indicative of the range of the target from the range finder.

19. The method of claim 18, further comprising counting each received range code in a read access memory.

20. The method of claim 19, further comprising storing each range code in one of a plurality of memory locations in a content addressable memory, each memory location for storing any range code.

21. The method of claim 21, further comprising counting the number of each range code in a plurality of counters in the read access memory, each counter being associated with one of the memory locations.

22. The method of claim 21, further comprising augmenting the count in the counter by one for each memory location each time a range code is received at the memory location.

23. The method of claim 18, further comprising measuring and storing the highest count at any time.

24. The method of claim 23, further comprising outputting at a predetermined threshold the highest count as the range code that equates to the range of the target from the range finder.
